(19) United States
(12) Patent Application Publication
(10) Pub. No.: US 2016/0145099 A1
(43) Pub. Date: May 26, 2016

(54) METHOD AND DEVICE FOR INTRODUCING REACTIVE GASSES INTO A REACTION CHAMBER

(71) Applicant: Hanno Tautz, Geretsried (DE)

(72) Inventor: Hanno Tautz, Geretsried (DE)

(21) Appl. No.: 14/938,315

(22) Filed: Nov. 11, 2015

(30) Foreign Application Priority Data
Nov. 20, 2014 (DE) 10 2014 017 118.3
Dec. 15, 2014 (DE) 10 2014 018 376.9

(51) Int. Cl. C01B 3/36; B01J 19/24

(52) U.S. Cl. CPC C01B 3/36; B01J 19/2415; B01J 2219/00157; B01J 2219/0015; B01J 2219/24; C01B 2203/0255; C01B 2203/1241

(57) ABSTRACT

A method and a device for the separate introduction of a fuel gas and also of an oxidizing agent into the reaction chamber of a tubular reactor, in order there to be mixed and reacted with the release of heat. Not only the fuel gas but also the oxidizing agent are introduced into the reaction chamber in each case in more than three gas jets, wherein the margin between a fuel gas jet and an oxidizing agent jet as adjacent as possible thereto, on entry into the reaction chamber, is between 2 and 500 mm, preferably between 5 and 50 mm.

### CROSS REFERENCE TO RELATED APPLICATIONS

This application claims priority from German Patent Application DE 10 2014 017 118,3 filed Nov. 20, 2014 and German Patent Application DE 10 2014 018 376.9 filed Dec. 15, 2014.

### BACKGROUND OF THE INVENTION

The invention relates to a method and also to a device for the separate introduction of a fuel gas and also of an oxidizing agent into the reaction chamber of a tubular reactor, in order there to be mixed and reacted with the release of heat.

A tubular reactor, as is known, for example, from the patent DE10320965B4, is primarily used for generating synthesis gas by partial oxidation, for which purpose a hydrocarbon-containing fuel gas is reacted together with an oxidizing agent in the reaction chamber of the reactor. For introducing the gasses that are to be reacted into the reaction chamber, jet burners or swirl burners are proposed, which have tubes arranged concentrically to one another in the burner head which form the feed channels for the gas streams, On account of the low diameter ratio of reaction chamber and burner head, there is the risk of developing static sound waves during the operation of a tubular reactor, which static sound waves can interfere with burner operation, In addition, soot formation is reinforced by the low-flow zones in the region of the gas outlet. Since a certain margin from the gas outlet velocity must always be maintained for the flame velocity, furthermore, the load range in which such burners can be operated in a stable manner is restricted. Sometimes, therefore, special pre-heating burners are used with which the cold reactor is brought to the ignition temperature of the gasses used, and which must be removed from the hot reactor before adopting standard operation.

The conduction of the gasses that are to be reacted in feed channels separated from one another only by a tube wall favors the formation of damage. For instance, the oxidizing agent conducted in a channel, for example, can react with the inflowing fuel gas in a directly adjacent channel in the immediate vicinity of the joint outlet rim, in such a manner that this can be damaged by burn-off of tube material.

A further problem when such burners are used can result from the flame length. In particular in startup processes in which the pressure in the reaction chamber is usually far lower than during standard operation, there is the risk that the burner flame contacts the walls of the reaction chamber and there leads to intense thermal stress.

It is therefore the object of the present invention to achieve a method and also a device of the type in question which overcome the disadvantages of the prior art.

### SUMMARY OF THE INVENTION

This object is achieved according to the invention in terms of the method in that not only the fuel gas but also the oxidizing agent are introduced into the reaction chamber in each case in more than three gas jets, wherein the spacing between a fuel gas jet and an oxidizing agent jet as adjacent as possible thereto, on entry into the reaction chamber, is between 2 and 500 mm, preferably between 5 and 50 mm.

Further embodiments of the method according to the invention provide that
the oxidizing agent jets are introduced into the reaction chamber in parallel to one another.
at least one fuel gas jet is assigned to an oxidizing agent jet in such a manner that the axes of the two gas jets enclose an angle which is between 5° and 75°, preferably between 20° and 60°.
at least two fuel gas jets are assigned to an oxidizing agent jet in such a manner that they drive a turbulent flow around the axis of the oxidizing agent jet.
fuel gas and oxidizing agent are introduced into the reaction chamber at minimum velocities which are greater in each case by the factor 1/F than the mean flow velocity of the product gas formed in the reaction of the two gasses in the reaction chamber of the tubular reactor, wherein F is dependent on the pressure p in the reaction chamber in accordance with the formula F=A*p^{(0.398)} where A is a number between 0.25 and 2.5.
the number of the fuel gas jets and oxidizing agent jets is increased or lowered depending on the thermal output to be released in the reaction chamber.
the diameters and/or the number of the gas jets per unit area over the cross-sectional area of the tubular reactor are identical or different.

In addition, the invention relates to a device for the separate introduction of feed gasses into the reaction chamber of a tubular reactor, having feed channels for a fuel gas and an oxidizing agent, which feed channels end on the reaction chamber side in outlet openings.

In terms of the device, the object in question is achieved according to the invention in that not only the feed channels for the fuel gas but also those for the oxidizing agent end in at least three outlet openings, wherein the spacing between an outlet opening for the fuel gas and an outlet opening for the oxidizing agent as adjacent as possible thereto is between 2 and 500 mm, preferably between 5 and 50 mm, and wherein the outlet ends of the feed channels are surrounded by a thermal insulating material or are formed by a thermal insulating material

Further embodiments of the device according to the invention provide that
the outlet ends of the feed channels for the oxidizing agent are arranged parallel to one another.
a feed channel for fuel gas is assigned to each feed channel for oxidizing agent, wherein the axes of the outlet ends of the two channels enclose an angle which is between 5° and 75°, preferably between 20° and 60°.
all outlet openings are arranged in exactly one plane parallel to the longitudinal axis of the reaction chamber.
the outlet end of a feed channel is constructed as a diffuser or as a converging nozzle.
an outlet opening has a diameter between 2 and 20 mm, but preferably between 5 and 10 mm.
the thermal insulating material is arranged in the tubular reactor in such a manner that a gas chamber is separated off from the reaction chamber on the gas intake side of the tubular reactor, which gas chamber can be used for distribution of fuel gas over the outlet openings.
an oxidizing agent channel and the fuel gas channel or channels assigned to said oxidizing agent channel are consolidated together with the thermal insulating material surrounding them in a burner module.
a burner module having at least one second burner module that is identical thereto or different therefrom is consolidated to form a unit which has a surface which is closed on the reaction chamber side.

the diameters and/or the number of the feed channels per unit area over the cross-sectional area of the tubular reactor are identical or different.

### BRIEF DESCRIPTION OF THE DRAWINGS

As a result of the allocation according to the invention of fuel gas and oxidizing agent to a multiplicity of gas jets, the flame length can be reduced and the temperature profile over the cross section of the reaction chamber homogenized. The spacing between fuel gas jets and oxidizing agent jets ensures a displacement of the mixing zone of the two gas types away from the device used for the introduction thereof, in such a manner that the thermal loading of the device is decreased in comparison with the prior art.

Hereinafter, the invention will be explained with reference to three exemplary embodiments which are shown schematically in FIGS. 1 to 3.

FIG. 1 shows a tubular reactor having a burner according to the invention

FIGS. 2 and 3 show examples of possible forms of burner modules and the arrangement thereof. The view is from the reaction chamber in the direction of the longitudinal axis of the tubular reactor.

### DETAILED DESCRIPTION OF THE INVENTION

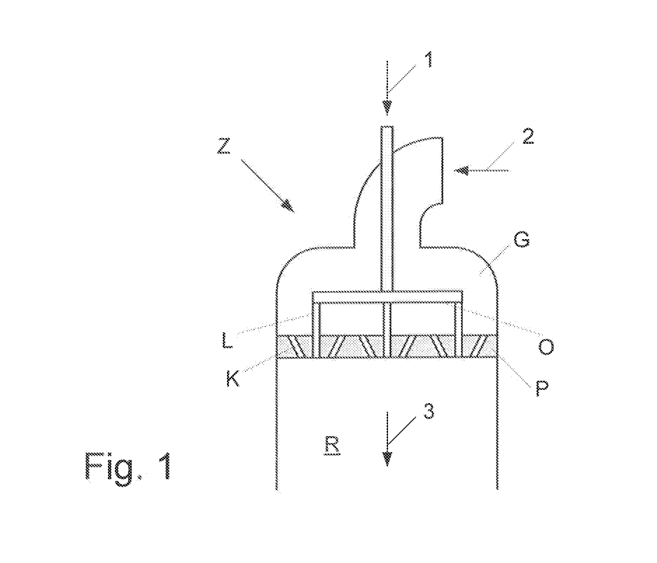

At the top end of the tubular reactor Z shown in longitudinal section in FIG. 1, a burner according to the invention is arranged, via which a fuel gas 2 can be introduced alone or mixed with steam, and also an oxidizing agent 1, into the reaction chamber R. The burner comprises a plate P made of a thermally insulating material which fills the cross section of the reaction chamber R and separates it off from the gas chamber G. The fuel gas 2 which is, for example, natural gas, is distributed via the gas chamber C onto the fuel gas channels K, optionally with steam, via which it passes into the reaction chamber R. The fuel gas channels K which are at an incline to the longitudinal axis of the tubular reactor are either formed directly by cutouts in the thermally insulating material of the plate P, or by tubes made of metal or ceramic which are surrounded by thermally insulating material. In the drawing, in each case two fuel gas channels K are assigned to an oxidizing agent channel L which proceeds in parallel to the longitudinal axis of the tubular reactor Z. Just as is the case for the fuel gas channels K, the same applies to the oxidizing agent channels L connected via the distributor line O, that they are either formed directly by cutouts in the thermally insulating material of the plate P, or are formed by tubes made of metal or ceramic, which are surrounded by thermally insulating material. As a result of the inclination of the fuel gas channels K with respect to an associated oxidizing agent channel L, the development of a turbulent flow in the synthesis gas 3 and thereby a short flame or reaction zone forms. In FIG. 1, a tubular reactor Z having a vertical longitudinal axis is shown, into the reaction chamber R of which fuel gas 2 and oxidizing agent 1 are introduced from the top toward the bottom. However, this must not exclude that the tubular reactor Z can have a longitudinal axis with any desired orientation and fuel gas 2 and oxidizing agent 1 are introducible into the reaction chamber R in correspondingly any desired orientation.

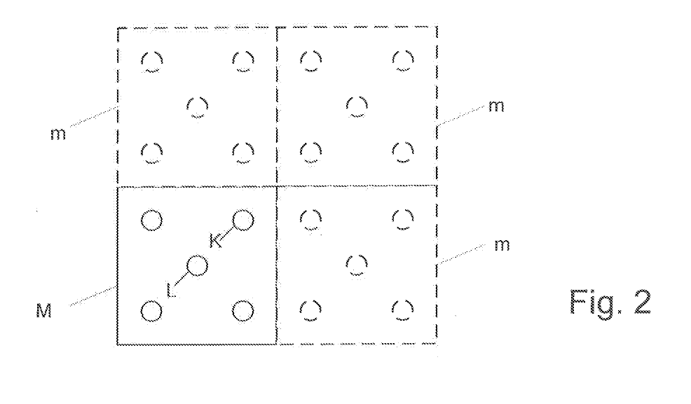

The burner module M shown in FIG. 2 has a square end surface, in the center of which the oxidizing agent channel L opens out. The four fuel gas channels K are assigned to the oxidizing agent channel L. In order to increase the burner output, a plurality of modules can be connected in such a manner that a closed surface results. An example thereof is the square formed from the burner module M and also the three identical modules m shown dashed.

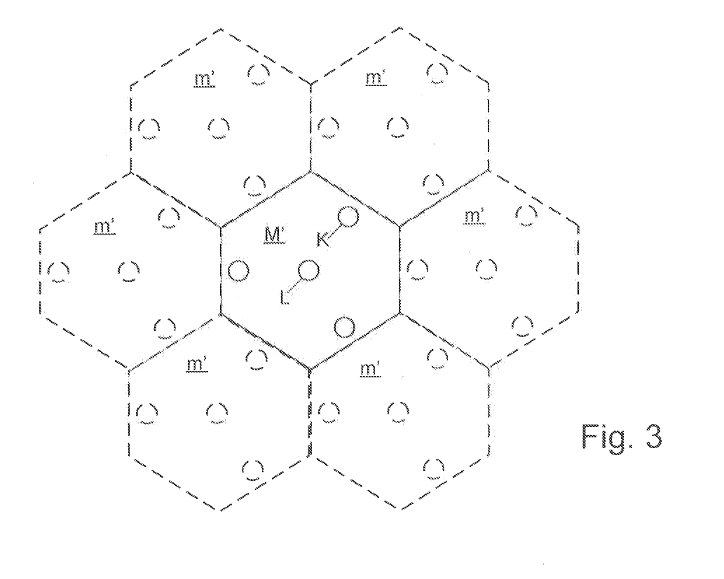

In FIG. 3, a burner module M′ has a hexagonal end surface, in the center of which the oxidizing agent channel L opens out. The three fuel gas channels K are assigned to the oxidizing agent channel L. In order to increase the burner output, a plurality of modules can be connected in such a manner that a closed surface results. An example thereof is the surface formed from the burner module M′ and also the six modules m′ shown dashed.

What claim is:

1. A method for the separate introduction of a fuel gas and an oxidizing agent into the reaction chamber of a tubular reactor, in order there to be mixed and reacted with the release of heat, characterized in that the fuel gas and also the oxidizing agent are introduced into the reaction chamber in more than three gas jets, wherein the spacing between a fuel gas jet and an oxidizing agent jet as adjacent as possible thereto, on entry into the reaction chamber, is between 2 and 500 mm.

2. The method according to claim 1, characterized in that the oxidizing agent jets are introduced into the reaction chamber in parallel to one another.

3. The method according to claim 2, characterized in that at least one fuel gas jet is assigned to an oxidizing agent jet in such a manner that the axes of the two gas jets enclose an angle which is between 5° and 75°.

4. The method according to claim 3, characterized in that at least two fuel gas jets are assigned to an oxidizing agent jet in such a manner that they drive a turbulent flow around the axis of the oxidizing agent jet.

5. method according to claim 1, characterized in that fuel gas and oxidizing agent are introduced into the reaction chamber at minimum velocities which are greater in each case by the factor 1/F than the mean flow velocity of the product gas formed in the reaction of the two gasses in the reaction chamber of the tubular reactor, wherein F is dependent on the pressure p in the reaction chamber in accordance with the formula F=A*p^{(-0.398)}, where A is a number between 0.25 and 2.5.

6. The method according to claim 1, characterized in that the number of the fuel gas jets and oxidizing agent jets is increased or lowered depending on the thermal output to be released in the reaction chamber.

7. The method according to claim 1, characterized in that the spacing between a fuel gas jet and an oxidizing agent jet as adjacent as possible thereto, on entry into the reaction chamber is between 5 and 50 mm.

8. The method according to claim 3, characterized in that the axes of the two gas jets enclose an angle which is between 20° and 60°.

9. A device for the separate introduction of feed gasses into the reaction chamber of a tubular reactor, having feed channels for a fuel gas and an oxidizing agent, which feed channels end on the reaction chamber side in outlet openings, characterized in that the feed channels for the fuel gas and the oxidizing agent end in at least three outlet openings, wherein the margin between an outlet opening for the fuel gas and an outlet opening for the oxidizing agent as adjacent as possible thereto is between 2 and 500 mm, and wherein the outlet ends of the feed channels are surrounded by a thermal insulating material or are formed by a thermal insulating material.

10. The device according to claim 9, characterized in that the outlet ends of the feed channels for the oxidizing agent are arranged parallel to one another.

11. The device according to claim 10, characterized in that a feed channel for fuel gas is assigned to each feed channel for oxidizing agent, wherein the axes of the outlet ends of the two channels enclose an angle which is between 5° and 75°.

12. The device according to claim 9, characterized in that all outlet openings are arranged in exactly one plane parallel to the longitudinal axis of the reaction chamber.

13. The device according to claim 9, characterized in that the outlet end of a feed channel is constructed as a diffuser or as a converging nozzle.

14. The device according to claim 9, characterized in that an outlet opening has a diameter between 2 and 20 mm.

15. The device according to claim 9, characterized in that the thermal insulating material is arranged in the tubular reactor in such a manner that a gas chamber is separated off from the reaction chamber on the gas intake side of the tubular reactor, which gas chamber can be used for distribution of fuel gas over the outlet openings.

16. The device according to claim 9, characterized in that an oxidizing agent channel and the fuel gas channel or channels assigned to said oxidizing agent channel are consolidated together with the thermal insulating material surrounding them in a burner module.

17. The device according to claim 16, characterized in that a burner module having at least one second burner module that is identical thereto or different therefrom is consolidated to form a unit which has a surface which is closed on the reaction chamber side.

18. The device according to claim 9, characterized in that the margin between an outlet opening for the fuel gas and an outlet opening for the oxidizing agent as adjacent as possible thereto is between 5 and 50 mm.

19. device according to claim 11, characterized in that the axes of the outlet ends of the two channels enclose an angle which is between 20° and 60°.

20. The device according to claim 14, characterized in that the outlet opening has a diameter between 5 and 10 mm.
